(19) United States
(12) Patent Application Publication
(10) Pub. No.: US 2009/0129242 A1
(43) Pub. Date: May 21, 2009

(54) OBJECTIVE LENS, OPTICAL PICKUP DEVICE HAVING THE SAME, AND RECORDING AND/OR REPRODUCING APPARATUS FOR OPTICAL RECORDING MEDIUM, EQUIPPED WITH THE OPTICAL PICKUP DEVICE

(76) Inventors: Toshiaki KATSUMA, Saitama-shi (JP); Masao Mori, Saitama-shi (JP); Tetsuya Ori, Saitama-shi (JP); Yu Kitahara, Saitama-shi (JP)

Correspondence Address: BIRCH STEWART KOLASCH & BIRCH, PO BOX 747, FALLS CHURCH, VA, 22040-0747, US

(21) Appl. No.: 12/273,193

(22) Filed: Nov. 18, 2008

(30) Foreign Application Priority Data
Nov. 19, 2007 (JP) P2007-299436

(51) Int. Cl. G11B 7/00

(52) U.S. Cl. 369/112.23; G9B/7

(57) ABSTRACT

An objective lens 8 consists of a single lens element. A light source side surface 8a is formed into a convex surface having a large curvature, and an optical recording medium side surface 8b has a small curvature. Also, the objective lens satisfies the following expressions (1) and (2)

ΦA/ΦB<5.0 (1)

7.69≦ΦA/ΦB+19.33×bf′/f′≦9.45 (2)
where ΦA denotes an effective diameter (mm) of the light source side surface of the objective lens 8,
   ΦB denotes an effective diameter (mm) of the optical recording medium side surface of the objective lens 8,
   bf′ denotes a back focal length (mm) of the objective lens 8, and
   f′ denotes a focal length (mm) of the objective lens 8.

### CROSS-REFERENCE TO RELATED APPLICATIONS

This application is based upon and claims the benefit of priority from the Japanese Patent Application No. 2007-299436 filed on Nov. 19, 2007; the entire contents of which are incorporated herein by reference.

### BACKGROUND OF THE INVENTION

1. Technical Field

The invention relates to an objective lens capable of efficiently converging used light onto an optical recording medium when information is recorded or reproduced, an optical pickup device and a recording and/or reproducing apparatus for the optical recoding medium. Specifically, the invention relates to an objective lens for used in recording/reproducing a high density optical recording medium with blue light having a short wavelength, an optical pickup device, and a recording and/or reproducing apparatus for the optical recording medium.

2. Description of the Related Art

Recently, various optical recording media such as DVD (digital versatile disc) and CD (compact disc which includes CD-ROM, CD-R, and CD-RW) have been widely used in various applications. However, in response to a rapid increase in data volume, an increase in storage capacity of an optical recording medium has been strongly demanded. It has been known that a decrease in wavelength of used light of a light source and an increase in numerical aperture (NA) of an objective lens are effective to increase a storage capacity of an optical recording medium. Based on this knowledge, the blu-ray disc (herein after referred to as “BD”) having about 25 GB in a single sided single layer has been put to practical use. For the BD, light which is emitted from a semiconductor laser (for example, emitting laser light having a wavelength of 405 nm) having a short wavelength light output is used as irradiation light, and a numerical aperture is increased to be equal to or greater than 0.7. In the specifications of the BD, the numerical aperture and a thickness of a protection layer (for example, the numerical aperture (NA) is 0.85, and the thickness of the protection layer is 0.1 mm) are set quietly different from those of DVD and CD.

However, in future, a further increase in density will inevitably be demanded, but it might be hard to satisfy this demand by promoting a decrease in wavelength. This is because optical transmittance of lens materials is rapidly reduced in the range of a wavelength λ less than 350 nm and thus, it is hard to obtain sufficient optical efficiency in practice.

Another way for achieving high density is to further increase the numerical aperture of the objective lens.

Meanwhile, when a lens having a large numerical aperture (hereinafter, it is referred to as a “high NA”) is designed, a single lens structure is effective to solve problems such as an increase in process number during assembly, deterioration in production efficiency, and an increase in cost.

Furthermore, in the high NA objective lens, it is important to prevent deterioration in aberration. Therefore, it is important to satisfactorily correct various aberrations by providing an aspheric surface or the like.

Generally, an objective lens for use in recording/reproducing an optical recording medium has a peculiar shape, that is, a convex surface which has a large curvature and is directed to a light source. In particular, if an objective lens is formed to have a high NA, a shape of the lens has great influence on not only a spherical aberration but also various aberrations.

Hence, in JP 2003-5032 A (corresponding to U.S. Pat. No. 7,110,344), a conditional expression relating to a sag amount is defined, and a value determined by the conditional expression is set in a predetermined allowable range, thereby preventing deterioration in various aberrations of the high NA lens.

Furthermore, the objective lens for recording/reproducing an optical recording medium tends to be too large in on-axis. Accordingly, in a high NA single lens, an on-axis thickness d is set to be in a predetermined range which is defined based on a relation between the thickness d and a focal length f, and so excellent image height characteristic are obtained (see JP 2001-324673 A (corresponding to U.S. Pat. No. 6,411,442) and JP 2003-5032 A).

In the above objective lens for recording and reproducing an optical recording medium, in order to decrease power when the focusing and tracking controls are performed, a light weight and a small size are required. On the other hand, the objective lens has such a peculiar shape that a convex surface having a large curvature is directed toward the light source side. Thus, manufacturability is apt to become worse, and it is difficult to sufficiently secure an operating distance. Hence, the objective lens is desired to have a configuration that can also solve this situation.

Specifically, the objective lenses described in JP 2001-324673 A and JP 2003-5032 A don't have a configuration that cannot always achieve both of (i) a small size and a light weight and (ii) ensuring the operating distance while rendering the manufacturability good. Accordingly, improvement has been demanded in this point of view.

The invention has been made in consideration of the situation mentioned above, and provides a high-performance objective lens for recording or reproducing information into or from an optical recording medium, the objective lens being capable of achieving a decrease in size and reduction in weight and ensuring an operating distance while improving manufacturability even when the objective lens is used as a single high NA lens capable of converging short wavelength light onto an optical recording layer. The invention also provides an optical pickup apparatus and a recording and/or reproducing apparatus for an optical recording medium.

According to an aspect of the invention, an objective lens converges used light on a desired position of an optical recording medium which information is recorded in and reproduced from. The objective lens consists of a single lens element having at least one aspheric surface. The following conditional expressions (1) and (2) are satisfied:

ΦA/ΦB≦5.0 (1)

7.69≦ΦA/ΦB+19.33×bf′/f′≦9.45 (2),
where ΦA denotes an effective diameter, in mm, of a light source side surface of the objective lens,
   ΦB denotes an effective diameter, in mm, of an optical recording medium side surface of the objective lens,
   bf′ denotes a back focal length of the objective lens in mm, and
   f′ denotes a focal length of the objective lens in mm.

It is more preferable that the following conditional expression (3) is satisfied in place of the conditional expression (1).

1.0≦ΦA/ΦB≦5.0 (3)

It is more preferable that the following conditional expression (3′) is satisfied in place of the conditional expression (1).

1.0≦ΦA/ΦB≦3.0 (3′)

It is more preferable that the following conditional expression (3″) is satisfied in place of the conditional expression (1).

1.0≦ΦA/ΦB≦2.0 (3″)

Also, it is preferable that the following conditional expression (4) is further satisfied.

1.0 mm≦ΦA≦5.0 mm (4)

Also, it is preferable that the following conditional expression (5) is further satisfied.

0.70≦NA≦0.98 (5)

Also, a wavelength of the used light may be 405.0±5.0 nm.

Also, a wavelength of the light may be 405.0±5.0 nm, the numerical aperture NA may be 0.85, and a thickness t of a protective layer of the optical recording medium may be 0.1 mm.

It is preferable that a wavelength of the light is 405.0±5.0 mm, that the numerical aperture NA is 0.85, that aberration is minimized at a position being distant t1 mm from a surface of the optical recording medium to an inside of the optical recording medium, and that the following conditional expression (6) is satisfied.

0.075≦t1≦0.1 (6)

It is preferable that a mass of the objective lens is 0.5 grams or less.

According to another aspect of the invention, an optical pickup device includes the objective lens set forth above, and an actuator that performs a focusing operation of the objective lens and a tracking operation of the objective lens.

According to further another aspect of the invention, a recording and/or reproducing apparatus for an optical recording medium includes the optical pickup device set forth above.

The objective lens according to the aspect of the invention is configured to satisfy the conditional expression (1). A ratio of ΦA/ΦB is defined to be 5.0 or less, where ΦB denotes the effective diameter of the optical recording medium side surface of the objective lens, and ΦA denotes the effective diameter of the light source side surface of the objective lens. Thereby, it is possible to achieve a decrease in size and reduction in weight.

Also, the objective lens is configured to satisfy the conditional expression (2). A sum of a value of ΦA/ΦB and a value of the back focal length bf′ is defined to be in a predetermined range. Thereby, it is possible to provide a high-performance objective lens capable of achieving both of (i) the decrease in size and the reduction in weight and (ii) ensuring the operating distance while improving the manufacturability.

In addition, at least one surface of the objective lens is formed into an aspheric surface. Therefore, it is possible to satisfactorily correct various aberrations such as a spherical aberration and a coma aberration.

Furthermore, if the objective lens consists of the single lens element, alignment adjustment during assembly is not required, and production efficiency and reduce costs can be achieved.

The optical pickup device and the recording and/or reproducing apparatus according to the aspect of the invention include the objective lens of the aspect of the invention. Therefore, it is possible to obtain the same effect as the objective lens.

### BRIEF DESCRIPTION OF THE DRAWINGS

FIG. 1 is a section diagram schematically illustrating an objective lens according to Example 1 of the invention.

FIG. 2 is a section diagram schematically illustrating an objective lens according to Example 2 of the invention.

FIG. 3 is a section diagram schematically illustrating an objective lens according to Example 3 of the invention.

FIG. 4 is a section diagram schematically illustrating an objective lens according to Example 4 of the invention.

FIG. 5 is a section diagram schematically illustrating an objective lens according to Example 5 of the invention.

FIG. 6 is a schematic diagram illustrating an optical pickup device (an optical recording medium recording and/or reproducing apparatus) equipped with the objective lens according to an embodiment of the invention.

FIG. 7 is a graph showing a range defined by conditional expressions (1) and (2) for the objective lens according to the embodiment of the invention.

FIG. 8 is a diagram illustrating wavefront aberration in the objective lens according to Example 1 of the invention.

FIG. 9 is a diagram illustrating wavefront aberration in the objective lens according to Example 2 of the invention.

FIG. 10 is a diagram illustrating wavefront aberration in the objective lens according to Example 3 of the invention.

FIG. 11 is a diagram illustrating wavefront aberration in the objective lens according to Example 4 of the invention.

FIG. 12 is a diagram illustrating wavefront aberration in the objective lens according to Example 5 of the invention.

FIG. 13 is a diagram illustrating wavefront aberration in the objective lens according to Example 6 of the invention.

FIG. 14 is a diagram illustrating wavefront aberration in the objective lens according to Example 7 of the invention.

FIG. 15 is a diagram illustrating wavefront aberration in the objective lens according to Example 8 of the invention.

FIG. 16 is a diagram illustrating wavefront aberration in the objective lens according to Example 9 of the invention.

FIG. 17 is a diagram illustrating wavefront aberration in the objective lens according to Example 10 of the invention.

FIG. 18 is a diagram illustrating wavefront aberration in the objective lens according to Example 11 of the invention.

FIG. 19 is a diagram illustrating wavefront aberration in the objective lens according to Example 12 of the invention.

### DETAILED DESCRIPTION OF EMBODIMENTS OF THE INVENTION

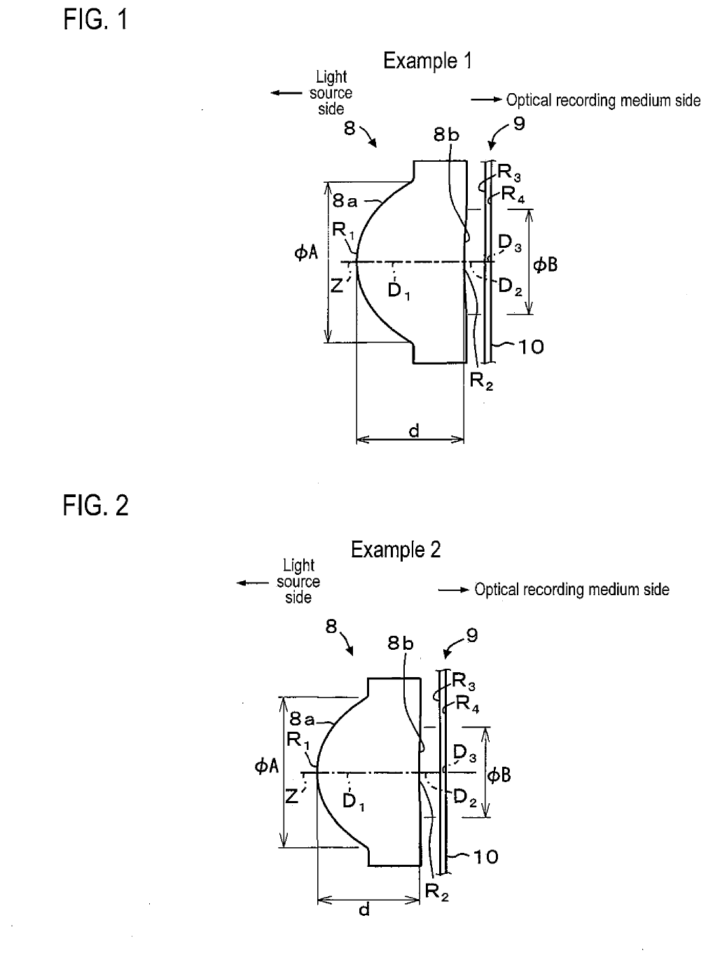

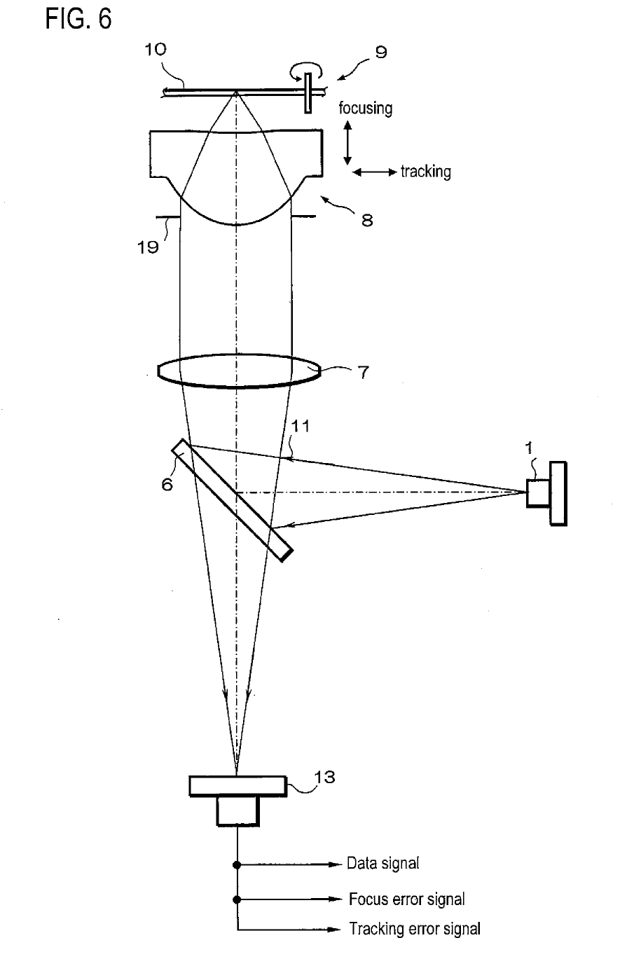

Hereinafter, with reference to the accompanying drawings, embodiments of the invention will be described. FIG. 1 is a schematic diagram showing a representative example of an objective lens 8 according to Example 1, in order to explain the configuration of the objective lens for an optical recording medium according to an embodiment of the invention. Furthermore, FIG. 6 is a diagram showing an optical pickup device and the partial configuration of a recording and/or reproducing apparatus for the optical recording medium, and is one exemplary configuration having the objective lens 8 according to this embodiment.

In the optical pickup device shown in FIG. 6, laser light 11 output from a semiconductor laser 1 is substantially collimated via a half mirror 6 and a collimator lens 7, and is incident on an objective lens 8 for an optical recording medium. Also, the laser light 11 is converted into convergent light by the objective lens 8, and is applied onto an optical recording layer 10 of an optical recording medium 9 (hereinafter, referred to as a blu-ray disc). Furthermore, in order to converge the light onto the optical recording layer 10 satisfactorily, the objective lens 8 performs tracking and focusing by using a servo mechanism including an actuator (which is not shown in the figure).

The objective lens 8 is configured to satisfy the following two conditional expressions (1) and (2)

ΦA/ΦB≦5.0 (1)

7.69≦ΦA/ΦB+19.33×bf′/f′≦9.45 (2),
where ΦA denotes an effective diameter (mm) of a light source side surface of the objective lens 8,
   ΦB denotes an effective diameter (mm) of an optical recording medium side surface of the objective lens 8,
   bf′ denotes a back focal length (mm) of the objective lens 8, and
   f′ denotes a focal length (mm) of the objective lens 8.

The optical recording medium 9 conforms to the following standard. A numerical aperture NA=0.85 (for example, which can be changed in the range of 0.7<NA<0.98). A wavelength λ of used light=404.7 nm (for example, which can be changed in the range of 405.0±5.0 nm, and 404.7 nm in Examples 1 and 2; 408.0 nm in Example 3; and 405.0 nm in Examples 4 to 12). A thickness t of a protection layer=0.1 mm (0.1 mm in Examples 1 to 3, 6 to 9 and 11; and in Examples 4, 5, 10 and 12, the optical recording medium is a double layer disc, and when a thickness t of the protection layer is considered in view of a design for the double layer disc, 0.0875 mm which is a distance from a surface to a position where aberration is minimized is used instead of the thickness of the actual protection layer). In the double layer disc, respective record layers are provided at distances of 0.075 mm and 0.100 mm from the disc surface. In order to compatible with such a disc configuration, the objective lens for the double layer disc is configured so that aberration becomes better in the middle part (which is located at the distance of 0.0875 mm from the surface) between the two record layers. Also, this embodiment of the invention does not exclude the case where the objective lens is used as an objective lens for recording/reproducing information into/from an optical recording medium using other short wavelength light such as a so-called AOD (HD-DVD) disc.

Also, the semiconductor laser 1 is a light source that outputs laser light of a blue wavelength region such as a wavelength of 404.7 nm for use in blu-ray discs.

Also, the collimator lens 7 is just schematically illustrated in FIG. 6, but is not limited to one element configuration. The collimator lens 7 may include plural lens elements.

As described above, a light flux output from the semiconductor laser 1 is incident on a light source side surface 8a of the objective lens 8 in a state of parallel light flux.

Also, by refractive action of the objective lens 8, it is possible to condense exit light flux from an optical recording medium side surface 8b of the objective lens 8 onto the optical recording layer 10, which can record or reproduce information, of the optical recording medium 9.

In the optical recording layer 10, pits (each of which is not necessary to have a concave shape physically) which carry signal information are arranged in a track manner. The reflected light of the laser light 11 from the optical recording layer 10 is incident on the half mirror 6 via the objective lens 8 and the collimator lens 7 in a state where the light carries signal information, and passes through the half mirror 6 to be incident on a four-divided photo diode 13. In the photo diode 13, a light receiving amount of each of the four divided positions of the diode is obtained as an electric signal. Thus, on the basis of the light receiving amounts, a calculation device (not shown in the figure) performs predetermined calculation based on the light receiving amounts, and so it is possible to obtain data signals, an error signal for focusing and an error signal for tracking.

The half mirror 6 is inserted to be inclined at an angle of 45 degrees with respect to an optical path of the returning light from the optical recording medium 9. Therefore, the mirror 6 has the same function as a cylindrical lens, and the light beam transmitted through the half mirror 6 has astigmatism. Thereby, an amount of the focus error is determined in accordance with a shape of a beam spot of the returning light on the four-divided photo diode 13. Also, by inserting a grating between the semiconductor laser 1 and the half mirror 6, it becomes possible to detect a tracking error based on three beams.

The objective lens 8 according to this embodiment consists of a single lens element. As shown in FIG. 1, the light source side surface of the lens is formed into a convex surface having a relatively large curvature, and the optical recording medium side surface of the lens is formed into a surface having a relatively small curvature (this surface is a concave surface in Examples 1, 2, 4, 6, and 11, and is a convex surface in Examples 3, 5, 7 to 10 and 12). Since the objective lens is formed of the single lens element, there is no need to adjust alignment between lenses, during assembly. As a result, it is possible to improve production efficiency and reduce costs.

Also, at least one surface of the objective lens 8 according to this embodiment is formed into an aspheric surface, and it is preferable that the both surfaces of the objective lens 8 be formed into aspheric surfaces. It is more preferable that the aspheric surfaces be formed of aspheric surfaces which is rotationally symmetric and is represented by the following aspherical expression. By forming such a rotationally symmetric aspheric surface, it is possible to satisfactorily correct various aberrations such as spherical aberration and comatic aberration. Thus, it is possible to surely perform the focusing operation and satisfactorily perform the recording and reproducing operations. It is also preferable that the shape of the aspheric surface formed on the objective lens 8 be appropriately set to converge light having a wavelength, which the aspheric surface acts, onto the optical recording layer 10 with aberrations being satisfactory corrected.

$$Z = \frac{C \times {Y}^{2}}{1 + \sqrt{1 - K \times {C}^{2} \times {Y}^{2}}} + {\sum }_{i = 3}^{20} {A}_{i} {\vert Y \vert}^{i}$$

where Z denotes a length of a perpendicular drawn from a point on the aspheric surface, which is distant Y from the optical axis, to a tangential plane (plane vertical to the optical axis) passing through a vertex of the aspheric surface,

Y denote the distance from the optical axis,

C denotes a curvature of the aspheric surface near the optical axis,

K denotes an eccentricity, and

Aᵢ denotes an aspherical coefficient (i=3 to 20).

Furthermore, a mask 19 having an aperture corresponding to the numerical aperture of the optical recording medium 9 is disposed on the light source side of the objective lens 8.

Also, the objective lens 8 may be made of plastic. Exemplary advantages of using a plastic material includes reduction in manufacturing costs, fast recording and reading enabled by reduction in weight, and improvement in processability of a mold.

Furthermore, the objective lens 8 may be made of glass. Exemplary advantages of using a glass material include excellent resistance to temperature and humidity, and ease of acquisition of the material, which has less deterioration in transmittance even when short wavelength light is applied thereto for a long time.

Also, in order to greatly reduce load of the actuator when the focusing and tracking operations are controlled during recording and reproducing a high density recording medium, it is preferable that a mass of the objective lens 8 is 0.5 grams or less.

As described above, the objective lens 8 according to this embodiment satisfies the conditional expressions (1) and (2). Hereinafter, the technical signification of this fact will be described.

First, as described above, the conditional expression (1) defines the ratio of ΦA/ΦB, where ΦB denotes the effective diameter of the optical recording medium side surface of the objective lens 8, and ΦA defines the effective diameter of the light source side surface of the objective lens 8. By satisfying the conditional expression (1), it is possible to prevent a diameter of the light source side surface from increasing excessively, while securing an appropriate operating distance.

Specifically, if ΦA/ΦB exceeds the upper limit of the conditional expression (1), it becomes difficult to decrease a size of the objective lens and to reduce a weight of the objective lens.

Next, the conditional expression (2) represents that the ratio of ΦA/ΦB is set to be in a predetermined range in relationship with a ratio of bf′/f′, that is, a ratio of the back focal length bf′ to the focal length f′. By satisfying the conditional expression (2), it is possible to obtain a high-performance objective lens capable of achieving (i) a decrease in size and reduction in weight and (ii) securing an operating distance while improving manufacturability.

Specifically, if ΦA/ΦB+19.33×bf′/f′ falls below the lower limit of the conditional expression (2), manufacturability deteriorates, and it becomes difficult to secure an appropriate operating distance. Meanwhile, if ΦA/ΦB+19.33×bf′/f′ exceeds the upper limit of the conditional expression (2), it becomes difficult to decrease a size of the objective lens and to reduce a weight of the objective lens.

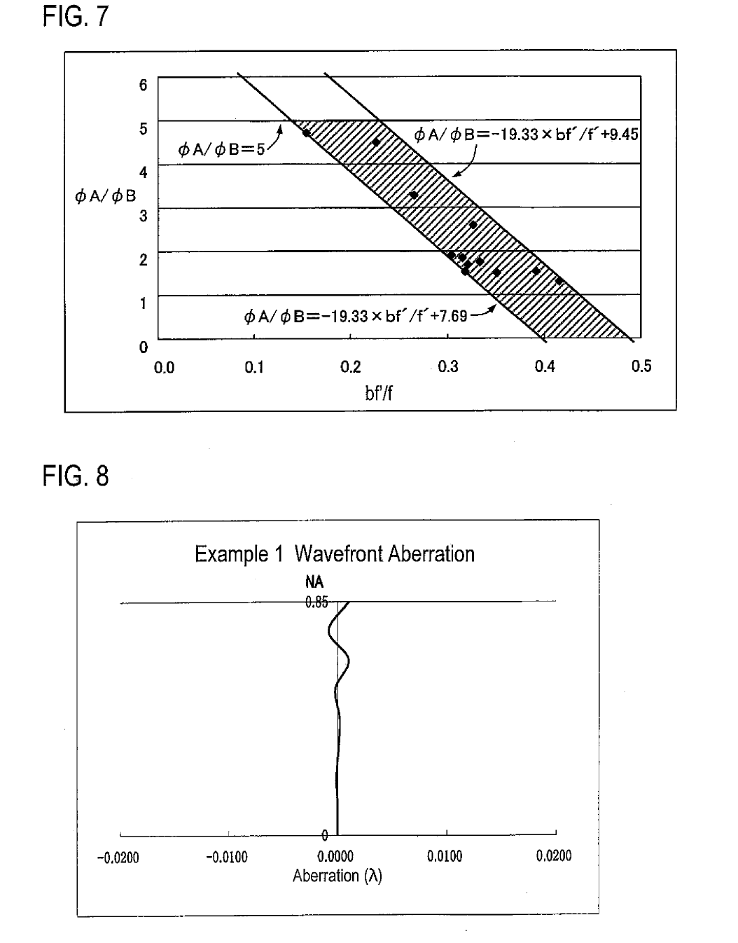

Here, a range satisfying all of the conditional expression (1) and the conditional expression (2) will be described. As shown in FIG. 7, the vertical axis represents bf′/f′, and the horizontal axis represents ΦA/ΦB. In this case, this range is determined by an area between ΦA/ΦB=5 and ΦA/ΦB=0 (this area includes the straight line representing ΦA/ΦB=5) and an area between ΦA/ΦB=−19.33×bf′/f′+7.69 and ΦA/ΦB=−19.33×bf′/f′+9.45 (this area includes the two straight lines). In FIG. 7, this range is represented by the hatching. Also, it can be observed that this range includes all of Examples 1 to 12 (which are represented by black dots).

The optical pickup device and the recording and/or reproducing apparatus according to the aspect of the invention include the objective lens of the aspect of the invention. Therefore, it is possible to obtain the same effect as the objective lens 8.

Furthermore, by satisfying the following conditional expression (3) instead of the conditional expression (1), it is possible to further improve the optical performance. That is, if ΦA/ΦB exceeds the upper limit of the conditional expression (3), it becomes difficult to decrease a size of the objective lens and to reduce a weight the objective lens, similarly to the case where ΦA/ΦB exceeds the upper limit of the conditional expression (1). In addition, if ΦA/ΦB falls below the lower limit of the conditional expression (3), it becomes difficult to maintain the good optical performance.

1.0≦ΦA/ΦB≦5.0 (3)

Furthermore, by satisfying the following conditional expression (3′) instead of the conditional expression (3), it is possible to improve the effect of the conditional expression (3).

1.0≦ΦA/ΦB≦3.0 (3′)

Furthermore, by satisfying the following conditional expression (3″) instead of the conditional expression (3), it is possible to greatly improve the effect of the conditional expression (3).

1.0≦ΦA/ΦB≦2.0 (3″)

In addition, in this embodiment, it is preferable that the following conditional expression (4) is satisfied.

1.0 mm≦ΦA≦5.0 mm (4)

If ΦA falls below the lower limit of the conditional expression (4), a size of the lens becomes too small, and manufacturability extremely deteriorates. In contrast, if ΦA exceeds the upper limit, it is hard to meet the demand of reduction in weight and demand of compactness.

Furthermore, in this embodiment, it is preferable that the following conditional expression (5) is satisfied.

0.70<NA<0.98 (5)

By setting a numerical aperture (NA) to be large, that is, in a range of 0.70 to 0.98, it becomes possible to decrease a diameter of a spot condensed onto the optical recording layer 10 of the optical recording medium 9 (blu-ray disk). Thus, even for an optical recording medium which will be newly developed in future, it is possible to achieve higher-density recording and reproducing.

Furthermore, in this embodiment, it is preferable that the following conditional expression (6) is satisfied

0.075≦t1≦0.1 (6),

where t1 denotes a distance (mm) from the lens side surface of the optical recording medium to a position inside the medium where aberration is minimized.

When the record layers of a double layer disc are provided in positions, which are distant 0.075 mm and 0.100 mm from the lens side surface to the inside of the medium, respectively, the conditional expression (6) serves as a conditional expression for forming a fine image on both of the record layer positions. If t1 is out of the range of the conditional expression (6), although an image formed in one recording surface position of the two record layers is fine, an image formed in the other recording surface position deteriorates. Thus, imaging states of the two surfaces become greatly different.

Furthermore, in order to improve an image formation state in each recording surface position, for example, the optical pickup device may have an aberration correction unit for performing adjustment by shifting the lens in the optical axis direction. In this case, the conditional expression (6) also serves as a conditional expression for decreasing a load applied to the optical pickup device such as a lens shift distance for correcting aberration. Because of this, it is possible to shorten a time for aberration correction.

Hereinafter, the objective lens according to the above embodiment will be described in detail with reference to Examples.

### EXAMPLE

### Example 1

The objective lens 8 according to Example 1 consists of a single lens element made of glass. As shown in FIG. 1, the light source side surface 8a is formed into a convex surface having a large curvature, and the optical recording medium side surface 8b is formed into a concave surface (on the optical axis) having a small curvature.

Furthermore, the both surfaces of the objective lens 8 according to Example 1 are formed into aspheric surfaces.

The objective lens 8 is set to have a numerical aperture NA of 0.85 at the used light having a wavelength λ of 404.7 nm, and satisfactory converges the light onto the optical recording layer 10 of the optical recording medium (blu-ray disc) 9. Also, the thickness t of the protection layer of the optical recording medium 9 is set to be 0.1000 mm.

The upper part of the following Table 1 shows the following items as specific values of lens data of the objective lens 8 according to Example 1: the radius of curvature R (mm); the surface spacing D (mm); and the refractive index N at the light having the wavelength λ. Furthermore, numerals corresponding to the radius of curvature R, the surface spacing D, and the refractive index N are arranged in ascending order from the light source side (this is similarly applied to Examples 2 to 12).

Furthermore, the middle part of the following Table 1 shows the aspherical coefficients C, K, and A₃ to A₂₀ of the rotationally symmetric aspheric surfaces of the objective lens 8 according to Example 1 (this is similarly applied to Examples 2 to 12).

In addition, the lower part of the following Table 1 shows the following items at the used light having the wavelength λ when the optical recording medium 9 is set: the following items are represented: the focal length f′ (mm); the back focal length bf′ (mm); the lens thickness d on the optical axis (mm); the protection layer thickness t (mm); the mass (gram) and the effective diameters ΦA and ΦB (mm) of the respective surfaces (the light source side surface 8a is referred to as a first surface, and the optical recording medium side surface 8b is referred to as a second surface: the same is applied to the following Examples) of the objective lens 8 according to Example 1 (these are similarly applied to Examples 2 to 12; it is noted that the mass is described only in Examples 2 to 5).

TABLE 1

| | | |
|---|---|---|
| Wavelength | λ (nm) | 404.7 |
| | NA | 0.85 |

| | Curvature radius | Surface separating | |
|---|---|---|---|
| Surface | R (mm) | D (mm) | Refractive index N |
| 1 | Aspheric surface | 2.660 | 1.83845 |
| 2 | Aspheric surface | 0.699 | 1.00000 |
| 3 | ∞ | 0.100 | 1.52977 |
| 4 | ∞ | | |

Coefficients of aspheric surface expression

| | 1st surface | 2nd surface |
|---|---|---|
| C | 0.548674175 | 0.080574297 |
| K | −1.061479418 × 10⁻³ | −5.611340754 × 10⁻² |
| A₃ | 0.000000000 | 0.000000000 |
| A₄ | 1.270519830 × 10⁻² | 3.758299557 × 10⁻² |
| A₅ | 0.000000000 | 0.000000000 |
| A₆ | 1.030368124 × 10⁻³ | −4.376347500 × 10⁻² |
| A₇ | 0.000000000 | 0.000000000 |
| A₈ | 1.005409026 × 10⁻⁴ | 1.130434946 × 10⁻² |
| A₉ | 0.000000000 | 0.000000000 |
| A₁₀ | 1.242029162 × 10⁻⁵ | 3.806010944 × 10⁻³ |
| A₁₁ | 0.000000000 | 0.000000000 |
| A₁₂ | −1.326556943 × 10⁻⁵ | −1.580726242 × 10⁻³ |
| A₁₃ | 0.000000000 | 0.000000000 |
| A₁₄ | 5.942473430 × 10⁻⁶ | −8.143251324 × 10⁻⁴ |
| A₁₅ | 0.000000000 | 0.000000000 |
| A₁₆ | −1.274070855 × 10⁻⁶ | 3.437625596 × 10⁻⁴ |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 2.2860 |
| Back focal length bf′ (mm) | 0.7644 |
| Lens thickness on optical axis d (mm) | 2.660 |
| Protection layer thickness t (mm) | 0.100 |
| Mass (gram) | 0.160 |
| Effective diameter of 1st surface φA (mm) | 3.8862 |
| Effective diameter of 2nd surface φB (mm) | 2.2337 |

Furthermore, FIG. 8 shows a wavefront aberration curve of the objective lens 8 according to Example 1 at the used light having the wavelength λ when the optical recording medium 9 is set.

As shown in FIG. 8, it is clearly observed that the wavefront aberration is good.

As shown in Table 13, the objective lens 8 according to Example 1 satisfies all the conditional expressions (1) to (6) (including the conditional expressions (3′) and (3″)).

### Example 2

The objective lens 8 according to Example 2 consists of a single lens element made of glass. As shown in FIG. 2, the light source side surface 8a is formed into a convex surface having a large curvature, and the optical recording medium side surface 8b is formed into a concave surface (on the optical axis) having a small curvature.

Also, the both surfaces of the objective lens 8 according to Example 2 are formed into aspheric surfaces.

The objective lens 8 is set to have a numerical aperture NA of 0.85 at the used light having a wavelength λ of 404.7 nm, and satisfactory converges the light onto the optical recording layer 10 of the optical recording medium (blu-ray disc) 9. Also, the thickness t of the protection layer of the optical recording medium 9 is set to be 0.1000 mm.

The upper part of the following Table 2 shows the following items as specific values of lens data of the objective lens 8 according to Example 2: the radius of curvature R (mm); the surface spacing D (mm); and the refractive index N at the light having the wavelength λ.

TABLE 2

| | | |
|---|---|---|
| Wavelength | λ (nm) | 404.7 |
| | NA | 0.85 |

| | Curvature radius | Surface separating | |
|---|---|---|---|
| Surface | R (mm) | D (mm) | Refractive index N |
| 1 | Aspheric surface | 2.210 | 1.83845 |
| 2 | Aspheric surface | 0.475 | 1.00000 |
| 3 | ∞ | 0.100 | 1.62000 |
| 4 | ∞ | | |

Coefficients of aspheric surface expression

| | 1st surface | 2nd surface |
|---|---|---|
| C | 0.689630774 | 0.039276841 |
| K | −8.688889711 × 10⁻³ | −5.619160401 × 10⁻² |
| A₃ | 0.000000000 | 0.000000000 |
| A₄ | 2.569152680 × 10⁻² | 1.630668463 × 10⁻¹ |
| A₅ | 0.000000000 | 0.000000000 |
| A₆ | 2.943292477 × 10⁻³ | −3.557924631 × 10⁻¹ |
| A₇ | 0.000000000 | 0.000000000 |
| A₈ | 1.573660098 × 10⁻³ | 2.181733794 × 10⁻¹ |
| A₉ | 0.000000000 | 0.000000000 |
| A₁₀ | −1.458312707 × 10⁻³ | 1.191817126 × 10⁻¹ |
| A₁₁ | 0.000000000 | 0.000000000 |
| A₁₂ | 9.914170566 × 10⁻⁴ | −1.230552513 × 10⁻¹ |
| A₁₃ | 0.000000000 | 0.000000000 |
| A₁₄ | −3.190780605 × 10⁻⁴ | −1.298144710 × 10⁻¹ |
| A₁₅ | 0.000000000 | 0.000000000 |
| A₁₆ | 1.869168441 × 10⁻⁵ | 1.211246037 × 10⁻¹ |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 1.7600 |
| Back focal length bf′ (mm) | 0.5367 |
| Lens thickness on optical axis d (mm) | 2.210 |
| Protection layer thickness t (mm) | 0.100 |
| Mass (gram) | 0.086 |
| Effective diameter of 1st surface φA (mm) | 2.9920 |
| Effective diameter of 2nd surface φB (mm) | 1.5624 |

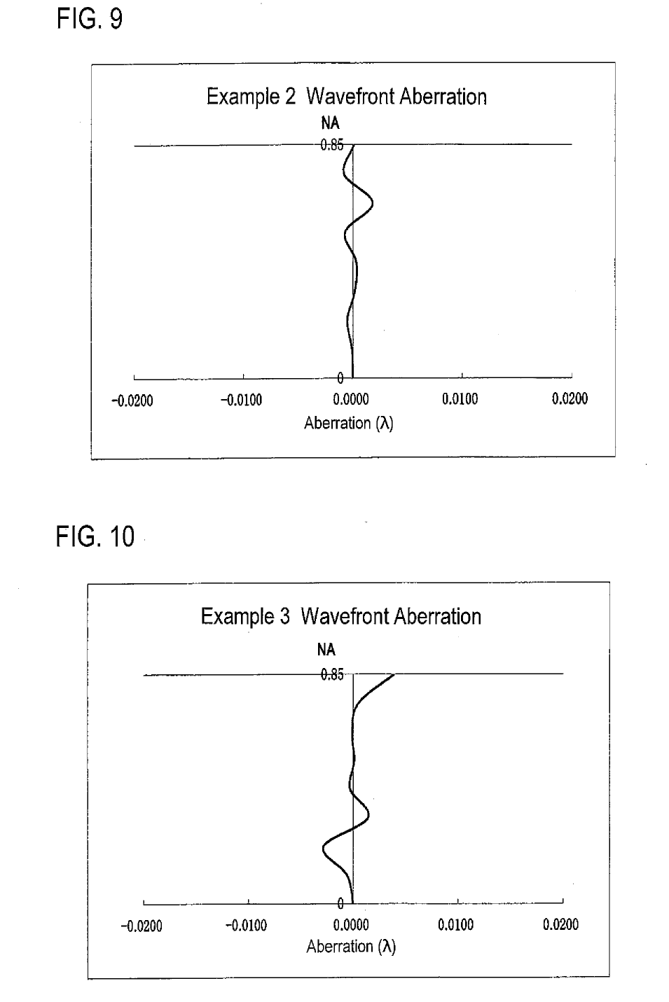

Furthermore, FIG. 9 shows a wavefront aberration curve of the objective lens 8 according to Example 2 at the used light having the wavelength λ when the optical recording medium 9 is set.

As shown in FIG. 9, it is clearly observed that the wavefront aberration is good.

As shown in Table 13, the objective lens 8 according to Example 2 satisfies all the conditional expressions (1) to (6) (including the conditional expressions (3′) and (3″)).

### Example 3

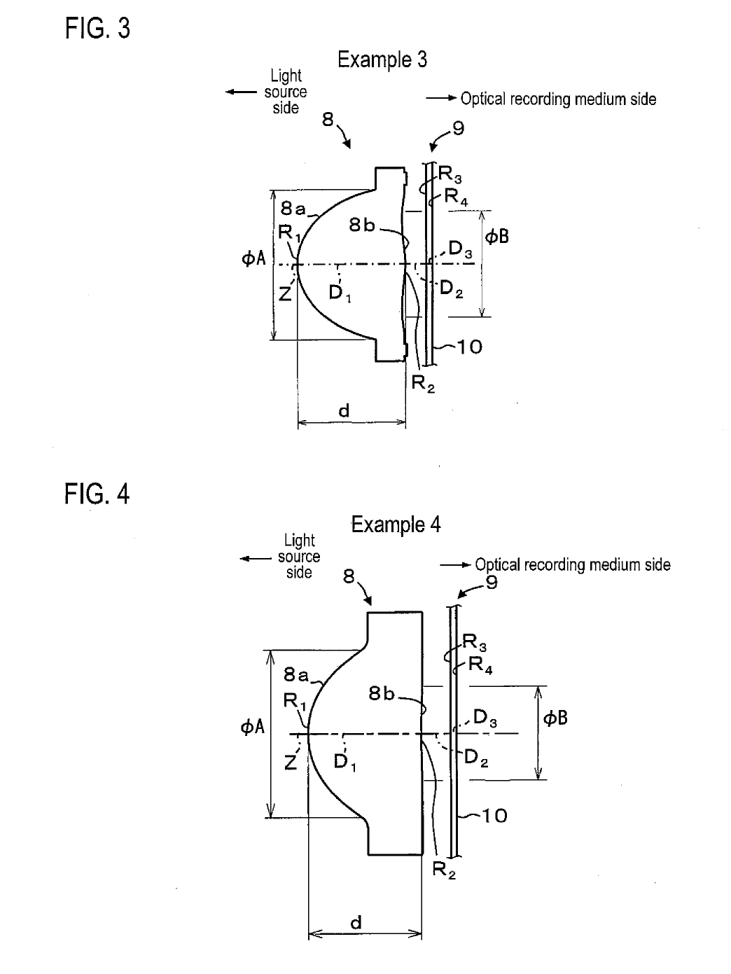

The objective lens 8 according to Example 3 consists of a single lens element made of plastic. As shown in FIG. 3, the light source side surface 8a is formed into a convex surface having a large curvature, and the optical recording medium side surface 8b is formed into a convex surface (on the optical axis) having a small curvature.

Furthermore, the both surfaces of the objective lens 8 according to Example 3 are formed into aspheric surfaces.

The objective lens 8 is set to have a numerical aperture NA of 0.85 at the used light having a wavelength λ of 408.0 nm, and satisfactory converges the light onto the optical recording layer 10 of the optical recording medium (blu-ray disc) 9. Also, the thickness t of the protection layer of the optical recording medium 9 is set to be 0.1000 mm.

The upper part of the following Table 3 shows the following items as specific values of lens data of the objective lens 8 according to Example 3: the radius of curvature R (mm); the surface spacing D (mm); and the refractive index N at the light having the wavelength λ.

TABLE 3

| | | |
|---|---|---|
| Wavelength | λ (nm) | 408 |
| | NA | 0.85 |

| | Curvature radius | Surface separating | |
|---|---|---|---|
| Surface | R (mm) | D (mm) | Refractive index N |
| 1 | Aspheric surface | 2.253 | 1.52522 |
| 2 | Aspheric surface | 0.502 | 1.00000 |
| 3 | ∞ | 0.100 | 1.61786 |
| 4 | ∞ | | |

Coefficients of aspheric surface expression

| | 1st surface | 2nd surface |
|---|---|---|
| C | 0.877164470 | −0.630277255 |
| K | 4.496547921 × 10⁻² | 1.524018153 |
| A₃ | 0.000000000 | 0.000000000 |
| A₄ | 3.823031376 × 10⁻² | 8.778900757 × 10⁻¹ |
| A₅ | 0.000000000 | 0.000000000 |
| A₆ | 3.518063967 × 10⁻³ | −1.557286522 |
| A₇ | 0.000000000 | 0.000000000 |
| A₈ | 1.858860704 × 10⁻² | 1.879314685 |
| A₉ | 0.000000000 | 0.000000000 |
| A₁₀ | −2.594878831 × 10⁻² | −1.370939101 |
| A₁₁ | 0.000000000 | 0.000000000 |
| A₁₂ | 2.385687100 × 10⁻² | 1.300798787 |
| A₁₃ | 0.000000000 | 0.000000000 |
| A₁₄ | −1.122473371 × 10⁻² | −2.270369528 |
| A₁₅ | 0.000000000 | 0.000000000 |
| A₁₆ | 2.344349476 × 10⁻³ | 2.611797039 |
| A₁₇ | 0.000000000 | 0.000000000 |
| A₁₈ | −8.484603101 × 10⁻⁵ | −1.482269017 |
| A₁₉ | 0.000000000 | 0.000000000 |
| A₂₀ | −8.752092239 × 10⁻⁶ | 3.299435201 × 10⁻¹ |

| | |
|---|---|
| Focal length f′ (mm) | 1.7654 |
| Back focal length bf′ (mm) | 0.5640 |
| Lens thickness on optical axis d (mm) | 2.253 |
| Protection layer thickness t (mm) | 0.100 |
| Mass (gram) | 0.015 |
| Effective diameter of 1st surface φA (mm) | 3.0011 |
| Effective diameter of 2nd surface φB (mm) | 1.9632 |

Furthermore, FIG. 10 shows a wavefront aberration curve of the objective lens 8 according to Example 3 at the used light having the wavelength λ when the optical recording medium 9 is set.

As shown in FIG. 10, it is clearly observed that the wavefront aberration is good.

As shown in Table 13, the objective lens 8 according to Example 3 satisfies all the conditional expressions (1) to (6) (including the conditional expressions (3′) and (3″)).

### Example 4

The objective lens 8 according to Example 4 consists of a single lens element made of glass. As shown in FIG. 4, the light source side surface 8a is formed into a convex surface having a large curvature, and the optical recording medium side surface 8b is formed into a concave surface (on the optical axis) having a small curvature.

Furthermore, the both surfaces of the objective lens 8 according to Example 4 are formed into aspheric surfaces.

The objective lens 8 is set to have a numerical aperture NA of 0.85 at the used light having a wavelength λ of 405.0 nm, and satisfactory converges the light having a specified light flux diameter onto the optical recording layer 10 of the optical recording medium (blu-ray disc) 9. Also, the optical recording medium 9 is a double layer disc. When a thickness t of the protection layer is considered in view of a design for the double layer disc, 0.0875 mm which is a distance from a surface to a position where aberration is minimized is used in place of the actual thickness of the protection layer.

The upper part of the following Table 4 shows the following items as specific values of lens data of the objective lens 8 according to Example 4: the radius of curvature R (mm); the surface spacing D (mm); and the refractive index N at the light having the wavelength λ.

TABLE 4

| | | |
|---|---|---|
| Wavelength | λ (nm) | 405 |
| | NA | 0.85 |

| | Curvature radius | Surface separating | |
|---|---|---|---|
| Surface | R (mm) | D (mm) | Refractive index N |
| 1 | Aspheric surface | 1.470 | 1.83833 |
| 2 | Aspheric surface | 0.318 | 1.00000 |
| 3 | ∞ | 0.0875 | 1.61900 |
| 4 | ∞ | | |

Coefficients of aspheric surface expression

| | 1st surface | 2nd surface |
|---|---|---|
| C | 1.020043332 | 0.018068790 |
| K | 2.619137643 × 10⁻² | −4.998689364 |
| A₃ | −1.636212462 × 10⁻³ | −1.058609924 × 10⁻² |
| A₄ | 8.702680781 × 10⁻² | 5.322862004 × 10⁻¹ |
| A₅ | −1.007631900 × 10⁻² | −2.855879205 × 10⁻¹ |
| A₆ | −3.872665379 × 10⁻² | −2.740661807 × 10⁻¹ |
| A₇ | 1.389458414 × 10⁻¹ | −2.757875038 |
| A₈ | 1.309803469 × 10⁻² | −2.808922015 |
| A₉ | −1.271309360 × 10⁻¹ | 1.959877807 |
| A₁₀ | −9.619290977 × 10⁻² | 1.749121483 × 10 |
| A₁₁ | 6.260776506 × 10⁻² | 2.589541494 × 10 |
| A₁₂ | 1.516934152 × 10⁻¹ | −7.605743196 |
| A₁₃ | 1.467006948 × 10⁻¹ | −7.440033486 × 10 |
| A₁₄ | −1.522983345 × 10⁻¹ | −8.297958500 × 10 |
| A₁₅ | −2.812044935 × 10⁻¹ | −3.452097139 × 10 |
| A₁₆ | 2.010179246 × 10⁻¹ | 2.651724208 × 10² |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 1.1760 |
| Back focal length bf′ (mm) | 0.3718 |
| Lens thickness on optical axis d (mm) | 1.470 |
| Protection layer thickness t (mm) | 0.0875 |
| Mass (gram) | 0.031 |
| Effective diameter of 1st surface φA (mm) | 1.9992 |
| Effective diameter of 2nd surface φB (mm) | 1.0898 |

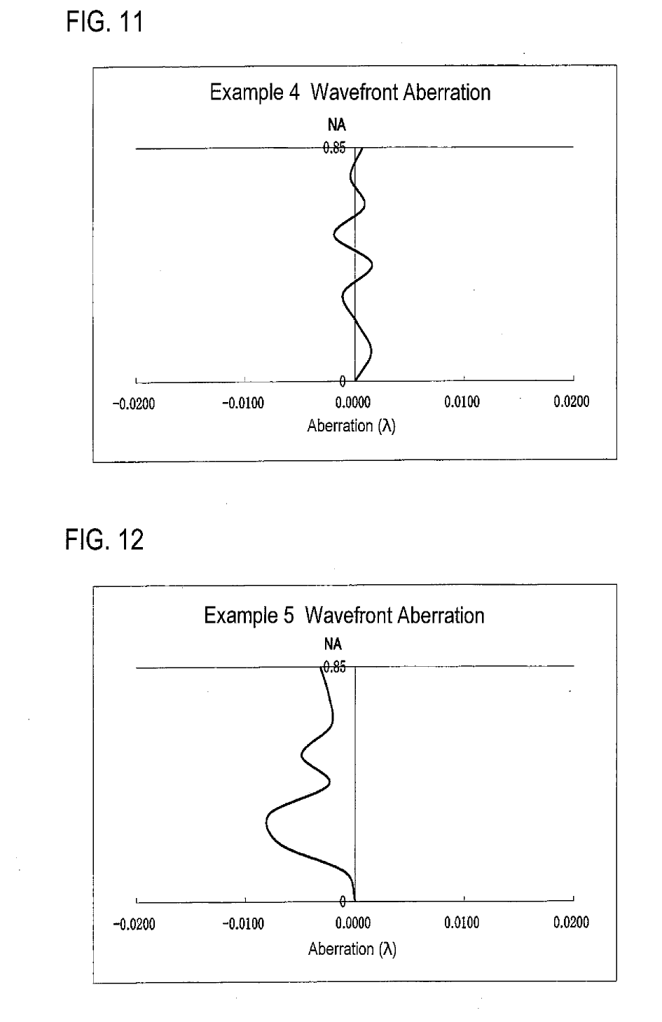

Furthermore, FIG. 11 shows a wavefront aberration curve of the objective lens 8 according to Example 4 at the used light having the wavelength λ when the optical recording medium 9 is set.

As shown in FIG. 11, it is clearly observed that the wavefront aberration is good.

As shown in Table 13, the objective lens 8 according to Example 4 satisfies all the conditional expressions (1) to (6) (including the conditional expressions (3′) and (3″)).

### Example 5

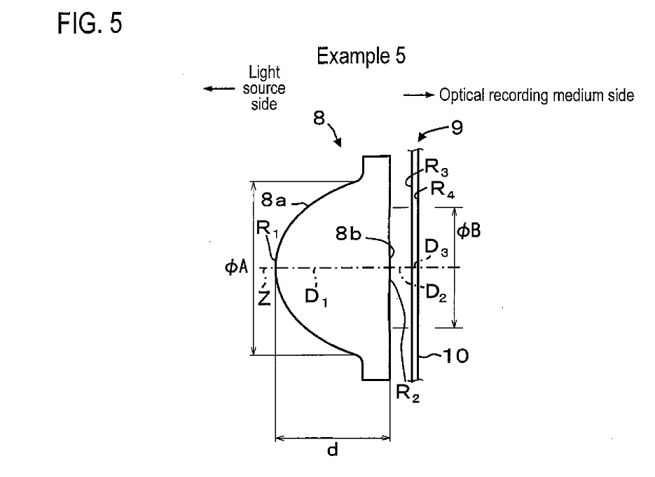

The objective lens 8 according to Example 5 consists of a single lens element made of glass. As shown in FIG. 5, the light source side surface 8a is formed into a convex surface having a large curvature, and the optical, recording medium side surface 8b is formed into a convex surface (on the optical axis) having a small curvature.

Furthermore, the both surfaces of the objective lens 8 according to Example 5 are formed into aspheric surfaces.

The objective lens 8 is set to have a numerical aperture NA of 0.85 at the used light having a wavelength λ of 405.0 nm, and satisfactory converges the light having a specified light flux diameter onto the optical recording layer 10 of the optical recording medium (blu-ray disc) 9. Also, the optical recording medium 9 is a double layer disc. When a thickness of the protection layer is considered in view of a design for the double layer disc, 0.0875 mm which is a distance from a surface to a position where aberration is minimized is used.

The upper part of the following Table 5 shows the following items as specific values of lens data of the objective lens 8 according to Example 5: the radius of curvature R (mm); the surface spacing D (mm); and the refractive index N at the light having the wavelength λ.

TABLE 5

| | | |
|---|---|---|
| Wavelength | λ (nm) | 405 |
| | NA | 0.85 |

| | Curvature radius | Surface separating | |
|---|---|---|---|
| Surface | R (mm) | D (mm) | Refractive index N |
| 1 | Aspheric surface | 2.580 | 1.60532 |
| 2 | Aspheric surface | 0.721 | 1.00000 |
| 3 | ∞ | 0.0875 | 1.61900 |
| 4 | ∞ | | |

Coefficients of aspheric surface expression

| | 1st surface | 2nd surface |
|---|---|---|
| C | 0.665963094 | −0.241274788 |
| K | 1.485482017 × 10⁻¹ | −1.592117057 |
| A₃ | 0.000000000 | 0.000000000 |
| A₄ | 1.458997407 × 10⁻² | 2.062426083 × 10⁻¹ |
| A₅ | 0.000000000 | 0.000000000 |
| A₆ | 1.248696532 × 10⁻³ | −1.965367777 × 10⁻¹ |
| A₇ | 0.000000000 | 0.000000000 |
| A₈ | 2.034812605 × 10⁻³ | 1.092415726 × 10⁻¹ |
| A₉ | 0.000000000 | 0.000000000 |
| A₁₀ | −1.289837288 × 10⁻³ | −2.610313432 × 10⁻² |
| A₁₁ | 0.000000000 | 0.000000000 |
| A₁₂ | 6.134250622 × 10⁻⁴ | −4.565082721 × 10⁻³ |
| A₁₃ | 0.000000000 | 0.000000000 |
| A₁₄ | −1.409898547 × 10⁻⁴ | 4.109929533 × 10⁻³ |
| A₁₅ | 0.000000000 | 0.000000000 |
| A₁₆ | 1.313656939 × 10⁻⁵ | −6.899202346 × 10⁻⁴ |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 2.2000 |
| Back focal length bf′ (mm) | 0.7747 |
| Lens thickness on optical axis d (mm) | 2.580 |
| Protection layer thickness t (mm) | 0.0875 |
| Mass (gram) | 0.073 |
| Effective diameter of 1st surface φA (mm) | 3.7400 |
| Effective diameter of 2nd surface φB (mm) | 2.4847 |

Furthermore, FIG. 12 shows a wavefront aberration curve of the objective lens 8 according to Example 5 at the used light having the wavelength λ when the optical recording medium 9 is set.

As shown in FIG. 12, it is clearly observed that the wavefront aberration is good.

As shown in Table 13, the objective lens 8 according to Example 5 satisfies all the conditional expressions (1) to (6) (including the conditional expressions (3′) and (3″)).

### Example 6

The objective lens 8 according to Example 6 consists of a single lens element made of glass. The objective lens 8 according to Example 6 is substantially similar to that according to Example 1, that is, the light source side surface 8a is formed into a convex surface having a large curvature, and the optical recording medium side surface 8b is formed into a concave surface (on the optical axis) having a small curvature.

Furthermore, the both surfaces of the objective lens 8 according to Example 6 are formed into aspheric surfaces.

The objective lens 8 is set to have a numerical aperture NA of 0.85 at the used light having a wavelength λ of 405 nm, and satisfactory converges the light onto the optical recording layer 10 of the optical recording medium (blu-ray disc) 9. Also, the thickness t of the protection layer of the optical recording medium 9 is set to be 0.1000 mm.

The upper part of the following Table 6 shows the following items as specific values of lens data of the objective lens 8 according to Example 6: the radius of curvature R (mm); the surface spacing D (mm); and the refractive index N at the light having the wavelength λ.

TABLE 6

| | | |
|---|---|---|
| Wavelength | (nm) | 405 |
| | NA | 0.85 |

| | | Curvature radius | Refractive |
|---|---|---|---|
| Surface | | R (mm) | index N |
| 1 | Aspheric surface | 2.682 | 1.83833 |
| 2 | Aspheric surface | 0.211 | 1.00000 |
| 3 | ∞ | 0.100 | 1.62000 |
| 4 | ∞ | | |

Coefficients of aspheric surface expression

| | 1st surface | 2nd surface |
|---|---|---|
| C | 0.690753100 | 0.084293790 |
| K | −4.050437116 × 10⁻² | 1.109127797 × 10 |
| A₃ | 0.000000000 | 0.000000000 |
| A₄ | 3.000813322 × 10⁻² | 1.810725029 |
| A₅ | 0.000000000 | 0.000000000 |
| A₆ | 8.370475371 × 10⁻⁴ | 4.672808949 × 10⁻¹ |
| A₇ | 0.000000000 | 0.000000000 |
| A₈ | 1.113162736 × 10⁻² | 2.548721676 × 10⁻¹ |
| A₉ | 0.000000000 | 0.000000000 |
| A₁₀ | −1.289604681 × 10⁻² | 7.432936994 × 10⁻² |
| A₁₁ | 0.000000000 | 0.000000000 |
| A₁₂ | 9.118383768 × 10⁻³ | 2.999905627 × 10⁻² |
| A₁₃ | 0.000000000 | 0.000000000 |
| A₁₄ | −3.151728222 × 10⁻³ | 7.708587612 × 10⁻⁴ |
| A₁₅ | 0.000000000 | 0.000000000 |
| A₁₆ | 4.599508407 × 10⁻⁴ | 1.534568350 × 10⁻² |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 1.7602 |
| Back focal length bf′ (mm) | 0.2731 |
| Lens thickness on optical axis d (mm) | 2.682 |
| Protection layer thickness t (mm) | 0.100 |
| Effective diameter of 1st surface φA (mm) | 2.9924 |
| Effective diameter of 2nd surface φB (mm) | 0.6356 |

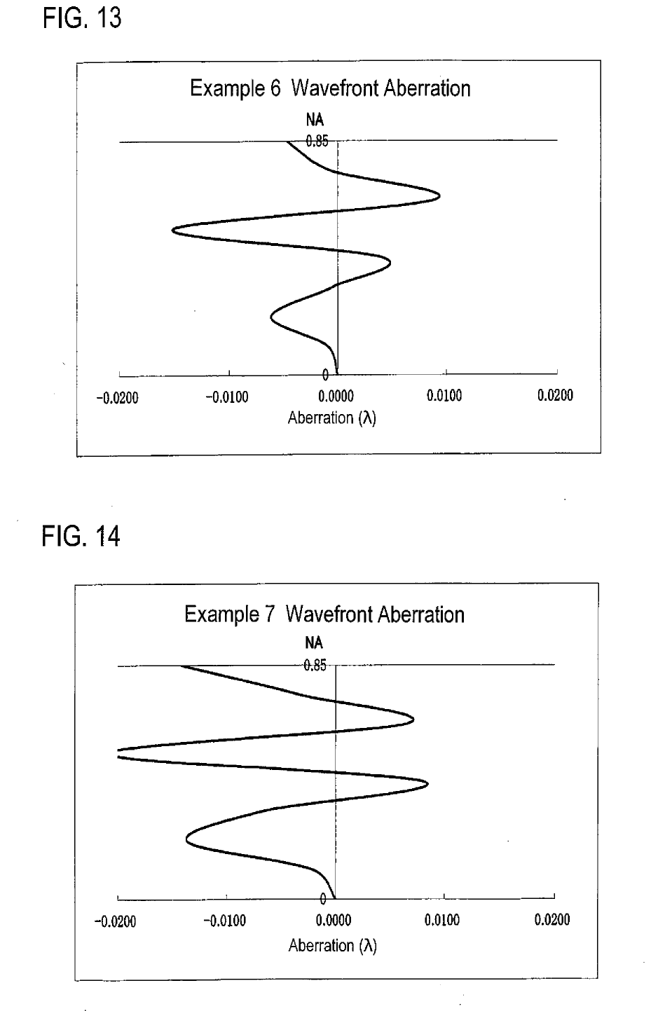

Furthermore, FIG. 13 shows a wavefront aberration curve of the objective lens 8 according to Example 6 at the used light having the wavelength λ when the optical recording medium 9 is set.

As shown in FIG. 13, it is clearly observed that the wavefront aberration is good.

As shown in Table 13, the objective lens 8 according to Example 6 satisfies all the conditional expressions (1) to (6).

### Example 7

The objective lens 8 according to Example 7 consists of a single lens element made of glass. The objective lens 8 according to Example 7 is substantially similar to that according to Example 3, that is, the light source side surface 8a is formed into a convex surface having a large curvature, and the optical recording medium side surface 8b is formed into a convex surface (on the optical axis) having a small curvature.

Furthermore, the both surfaces of the objective lens 8 according to Example 7 are formed into aspheric surfaces.

The objective lens 8 is set to have a numerical aperture NA of 0.85 at the used light having a wavelength λ of 405 nm, and satisfactory converges the light onto the optical recording layer 10 of the optical recording medium (blu-ray disc) 9. Also, the thickness t of the protection layer of the optical recording medium 9 is set to be 0.1000 mm.

The upper part of the following Table 7 shows the following items as specific values of lens data of the objective lens 8 according to Example 7: the radius of curvature R (mm); the surface spacing D (mm); and the refractive index N at the light having the wavelength λ.

TABLE 7

| | | |
|---|---|---|
| Wavelength | (nm) | 405 |
| | NA | 0.85 |

| | | Curvature radius | Refractive |
|---|---|---|---|
| Surface | | R (mm) | index N |
| 1 | Aspheric surface | 2.594 | 1.83833 |
| 2 | Aspheric surface | 0.337 | 1.00000 |
| 3 | ∞ | 0.100 | 1.62000 |
| 4 | ∞ | | |

Coefficients of aspheric surface expression

| | 1st surface | 2nd surface |
|---|---|---|
| C | 0.653893475 | −0.105335879 |
| K | −4.044771364 × 10⁻² | 1.108961026 × 10 |
| A₃ | 0.000000000 | 0.000000000 |
| A₄ | 3.199641103 × 10⁻² | 3.493341864 |
| A₅ | 0.000000000 | 0.000000000 |
| A₆ | 1.958739900 × 10⁻⁴ | 6.501793965 × 10⁻¹ |
| A₇ | 0.000000000 | 0.000000000 |
| A₈ | 1.759427486 × 10⁻² | 2.640079831 × 10⁻¹ |
| A₉ | 0.000000000 | 0.000000000 |
| A₁₀ | −2.114945079 × 10⁻² | 7.279247496 × 10⁻² |
| A₁₁ | 0.000000000 | 0.000000000 |
| A₁₂ | 1.445267793 × 10⁻² | 2.927995265 × 10⁻² |
| A₁₃ | 0.000000000 | 0.000000000 |
| A₁₄ | −4.890757981 × 10⁻³ | 5.076505411 × 10⁻⁴ |
| A₁₅ | 0.000000000 | 0.000000000 |
| A₁₆ | 6.939458072 × 10⁻⁴ | 1.522265335 × 10⁻² |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 1.7600 |
| Back focal length bf′ (mm) | 0.3986 |
| Lens thickness on optical axis d (mm) | 2.594 |
| Protection layer thickness t (mm) | 0.100 |
| Effective diameter of 1st surface φA (mm) | 2.9920 |
| Effective diameter of 2nd surface φB (mm) | 0.6664 |

Furthermore, FIG. 14 shows a wavefront aberration curve of the objective lens 8 according to Example 7 at the used light having the wavelength λ when the optical recording medium 9 is set.

As shown in FIG. 14, it is clearly observed that the wavefront aberration is good.

As shown in Table 13, the objective lens 8 according to Example 7 satisfies all the conditional expressions (1) to (6).

### Example 8

The objective lens 8 according to Example 8 consists of a single lens element made of glass. The objective lens 8 according to Example 8 is substantially similar to that according to Example 3, that is, the light source side surface 8a is formed into a convex surface having a large curvature, and the optical recording medium side surface 8b is formed into a convex surface (on the optical axis) having a small curvature.

Furthermore, the both surfaces of the objective lens 8 according to Example 8 are formed into aspheric surfaces.

The objective lens 8 is set to have a numerical aperture NA of 0.85 at the used light having a wavelength λ of 405 nm, and satisfactory converges the light onto the optical recording layer 10 of the optical recording medium (blu-ray disc) 9. Also, the thickness t of the protection layer of the optical recording medium 9 is set to be 0.1000 mm.

The upper part of the following Table 8 shows the following items as specific values of lens data of the objective lens 8 according to Example 8: the radius of curvature R (mm); the surface spacing D (mm); and the refractive index N at the light having the wavelength λ.

TABLE 8

| | | |
|---|---|---|
| Wavelength | (nm) | 405 |
| | NA | 0.85 |

| | | Curvature radius | Refractive |
|---|---|---|---|
| Surface | | R (mm) | index N |
| 1 | Aspheric surface | 2.497 | 1.83833 |
| 2 | Aspheric surface | 0.405 | 1.00000 |
| 3 | ∞ | 0.100 | 1.62000 |
| 4 | ∞ | | |

Coefficients of aspheric surface expression

| | 1st surface | 2nd surface |
|---|---|---|
| C | 0.645224638 | −0.122601218 |
| K | −4.055695379 × 10⁻² | 1.108246262 × 10 |
| A₃ | 0.000000000 | 0.000000000 |
| A₄ | 2.530447726 × 10⁻² | 9.317246631 × 10⁻¹ |
| A₅ | 0.000000000 | 0.000000000 |
| A₆ | −1.399960470 × 10⁻³ | 1.952482914 × 10⁻¹ |
| A₇ | 0.000000000 | 0.000000000 |
| A₈ | 1.606373014 × 10⁻² | 1.929185902 × 10⁻¹ |
| A₉ | 0.000000000 | 0.000000000 |
| A₁₀ | −1.733458345 × 10⁻² | 5.940024480 × 10⁻² |
| A₁₁ | 0.000000000 | 0.000000000 |
| A₁₂ | 1.099625619 × 10⁻² | 2.509877034 × 10⁻² |
| A₁₃ | 0.000000000 | 0.000000000 |
| A₁₄ | −3.499819413 × 10⁻³ | −3.558988546 × 10⁻³ |
| A₁₅ | 0.000000000 | 0.000000000 |
| A₁₆ | 4.672556885 × 10⁻⁴ | −1.034568233 × 10⁻² |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 1.7600 |
| Back focal length bf′ (mm) | 0.4669 |
| Lens thickness on optical axis d (mm) | 2.497 |
| Protection layer thickness t (mm) | 0.100 |
| Effective diameter of 1st surface φA (mm) | 2.9920 |
| Effective diameter of 2nd surface φB (mm) | 0.9112 |

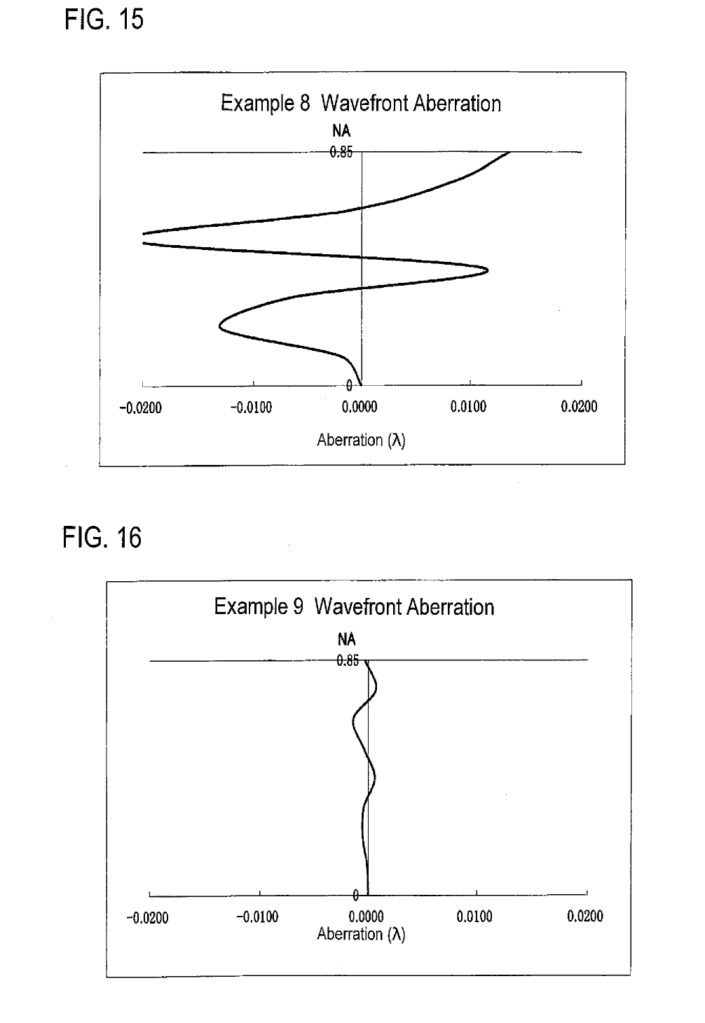

Furthermore, FIG. 15 shows a wavefront aberration curve of the objective lens 8 according to Example 8 at the used light having the wavelength λ when the optical recording medium 9 is set.

As shown in FIG. 15, it is clearly observed that the wavefront aberration is good.

As shown in Table 13, the objective lens 8 according to Example 8 satisfies all the conditional expressions (1) to (6).

### Example 9

The objective lens 8 according to Example 9 consists of a single lens element made of glass. The objective lens 8 according to Example 9 is substantially similar to that according to Example 3, that is, the light source side surface 8a is formed into a convex surface having a large curvature, and the optical recording medium side surface 8b is formed into a convex surface (on the optical axis) having a small curvature.

Furthermore, the both surfaces of the objective lens 8 according to Example 9 are formed into aspheric surfaces.

The objective lens 8 is set to have a numerical aperture NA of 0.85 at the used light having a wavelength λ of 405 nm, and satisfactory converges the light onto the optical recording layer 10 of the optical recording medium (blu-ray disc) 9. Also, the thickness t of the protection layer of the optical recording medium 9 is set to be 0.1000 mm.

The upper part of the following Table 9 shows the following items as specific values of lens data of the objective lens 8 according to Example 9: the radius of curvature R (mm); the surface spacing D (mm); and the refractive index N at the light having the wavelength λ.

TABLE 9

| | | |
|---|---|---|
| Wavelength | (nm) | 405 |
| | NA | 0.85 |

| | | Curvature radius | Refractive |
|---|---|---|---|
| Surface | | R (mm) | index N |
| 1 | Aspheric surface | 2.497 | 1.83833 |
| 2 | Aspheric surface | 0.514 | 1.00000 |
| 3 | ∞ | 0.100 | 1.62000 |
| 4 | ∞ | | |

Coefficients of aspheric surface expression

| | 1st surface | 2nd surface |
|---|---|---|
| C | 0.591065153 | −0.265122775 |
| K | −4.089482499 × 10⁻² | 1.108592503 × 10 |
| A₃ | 0.000000000 | 0.000000000 |
| A₄ | 1.402814533 × 10⁻² | 2.849711190 × 10⁻¹ |
| A₅ | 0.000000000 | 0.000000000 |
| A₆ | 1.109913433 × 10⁻³ | 8.164797737 × 10⁻² |
| A₇ | 0.000000000 | 0.000000000 |
| A₈ | 1.214805707 × 10⁻³ | 4.044176122 × 10⁻¹ |
| A₉ | 0.000000000 | 0.000000000 |
| A₁₀ | −3.151812010 × 10⁻⁴ | 2.483161386 × 10⁻¹ |
| A₁₁ | 0.000000000 | 0.000000000 |
| A₁₂ | 8.645546230 × 10⁻⁴ | 1.339059650 × 10⁻¹ |
| A₁₃ | 0.000000000 | 0.000000000 |
| A₁₄ | −4.128309301 × 10⁻⁴ | 4.897365366 × 10⁻² |
| A₁₅ | 0.000000000 | 0.000000000 |
| A₁₆ | 6.970946444 × 10⁻⁵ | 1.240492297 × 10⁻² |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 1.7600 |
| Back focal length bf′ (mm) | 0.5754 |
| Lens thickness on optical axis d (mm) | 2.497 |
| Protection layer thickness t (mm) | 0.100 |
| Effective diameter of 1st surface φA (mm) | 2.9920 |
| Effective diameter of 2nd surface φB (mm) | 1.1600 |

Furthermore, FIG. 16 shows a wavefront aberration curve of the objective lens 8 according to Example 9 at the used light having the wavelength λ when the optical recording medium 9 is set.

As shown in FIG. 16, it is clearly observed that the wavefront aberration is good.

As shown in Table 13, the objective lens 8 according to Example 9 satisfies all the conditional expressions (1) to (6) (including the conditional expression (3′)).

### Example 10

The objective lens 8 according to Example 10 consists of a single lens element made of glass. The objective lens 8 according to Example 10 is substantially similar to that according to Example 3, that is, the light source side surface 8a is formed into a convex surface having a large curvature, and the optical recording medium side surface 8b is formed into a convex surface (on the optical axis) having a small curvature.

Furthermore, the both surfaces of the objective lens 8 according to Example 10 are formed into aspheric surfaces.

The objective lens 8 is set to have a numerical aperture NA of 0.85 at the used light having a wavelength λ of 405 nm, and satisfactory converges the light onto the optical recording layer 10 of the optical recording medium (blu-ray disc) 9. Also, the optical recording medium 9 is a double layer disc. When a thickness of the protection layer is considered in view of a design for the double layer disc, 0.0875 mm which is a distance from a surface to a position where aberration is minimized is used in place of the actual thickness of the protection layer.

The upper part of the following Table 10 shows the following items as specific values of lens data of the objective lens 8 according to Example 10: the radius of curvature R (mm); the surface spacing D (mm); and the refractive index N at the light having the wavelength λ.

TABLE 10

| | | |
|---|---|---|
| Wavelength | (nm) | 405 |
| | NA | 0.85 |

| | | Curvature radius | Refractive |
|---|---|---|---|
| Surface | | R (mm) | index N |
| 1 | Aspheric surface | 1.467 | 1.60532 |
| 2 | Aspheric surface | 0.324 | 1.00000 |
| 3 | ∞ | 0.0875 | 1.61900 |
| 4 | ∞ | | |

Coefficients of aspheric surface expression

| | 1st surface | 2nd surface |
|---|---|---|
| C | 1.226490284 | −0.554482583 |
| K | 4.747046231 × 10⁻¹ | −2.646878301 |
| A₃ | 0.000000000 | 0.000000000 |
| A₄ | 1.672422412 × 10⁻² | 1.797335661 |
| A₅ | 0.000000000 | 0.000000000 |
| A₆ | 1.948718226 × 10⁻³ | −6.670223230 |
| A₇ | 0.000000000 | 0.000000000 |
| A₈ | 8.551225888 × 10⁻² | 1.652837181 × 10 |
| A₉ | 0.000000000 | 0.000000000 |
| A₁₀ | −1.964638371 × 10⁻¹ | −2.593923079 × 10 |
| A₁₁ | 0.000000000 | 0.000000000 |
| A₁₂ | 3.354630300 × 10⁻¹ | 2.312017390 × 10 |
| A₁₃ | 0.000000000 | 0.000000000 |
| A₁₄ | −2.789597572 × 10⁻¹ | −9.445302448 |
| A₁₅ | 0.000000000 | 0.000000000 |
| A₁₆ | 1.001639657 × 10⁻¹ | 9.728145385 × 10⁻¹ |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 1.1760 |
| Back focal length bf′ (mm) | 0.3781 |
| Lens thickness on optical axis d (mm) | 1.467 |
| Protection layer thickness t (mm) | 0.0875 |
| Effective diameter of 1st surface φA (mm) | 1.9992 |
| Effective diameter of 2nd surface φB (mm) | 1.1806 |

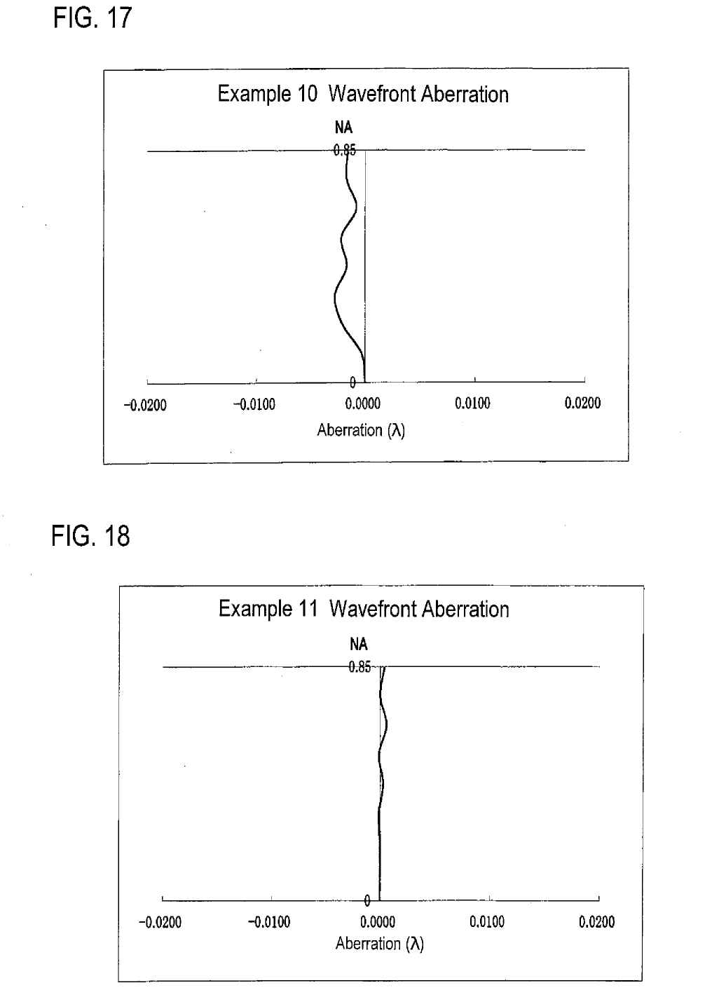

Furthermore, FIG. 17 shows a wavefront aberration curve of the objective lens 8 according to Example 10 at the used light having the wavelength λ when the optical recording medium 9 is set.

As shown in FIG. 17, it is clearly observed that the wavefront aberration is good.

As shown in Table 13, the objective lens 8 according to Example 10 satisfies all the conditional expressions (1) to (6) (including the conditional expressions (3′) and (3″)).

### Example 11

The objective lens 8 according to Example 11 consists of a single lens element made of glass. The objective lens 8 according to Example 11 is substantially similar to that according to Example 1, that is, the light source side surface 8a is formed into a convex surface having a large curvature, and the optical recording medium side surface 8b is formed into a concave surface (on the optical axis) having a small curvature.

Furthermore, the both surfaces of the objective lens 8 according to Example 11 are formed into aspheric surfaces.

The objective lens 8 is set to have a numerical aperture NA of 0.85 at the used light having a wavelength λ of 405 nm, and satisfactory converges the light onto the optical recording layer 10 of the optical recording medium (blu-ray disc) 9. Also, the thickness t of the protection layer of the optical recording medium 9 is set to be 0.1000 mm.

The upper part of the following Table 11 shows the following items as specific values of lens data of the objective lens 8 according to Example 11: the radius of curvature R (mm); the surface spacing D (mm); and the refractive index N at the light having the wavelength λ.

TABLE 11

| | | |
|---|---|---|
| Wavelength | (nm) | 405 |
| | NA | 0.85 |

| | | Curvature radius | Refractive |
|---|---|---|---|
| Surface | | R (mm) | index N |
| 1 | Aspheric surface | 1.850 | 1.83833 |
| 2 | Aspheric surface | 0.628 | 1.00000 |
| 3 | ∞ | 0.100 | 1.62000 |
| 4 | ∞ | | |

Coefficients of aspheric surface expression

| | 1st surface | 2nd surface |
|---|---|---|
| C | 0.720968003 | 0.110310758 |
| K | −4.036460797 × 10⁻² | 1.109167843 × 10 |
| A₃ | 0.000000000 | 0.000000000 |
| A₄ | 3.118352861 × 10⁻² | 8.298171648 × 10⁻² |
| A₅ | 0.000000000 | 0.000000000 |
| A₆ | 4.508653193 × 10⁻³ | −1.328753477 × 10⁻¹ |
| A₇ | 0.000000000 | 0.000000000 |
| A₈ | 2.125480881 × 10⁻⁴ | 6.683328832 × 10⁻² |
| A₉ | 0.000000000 | 0.000000000 |
| A₁₀ | 1.037399447 × 10⁻³ | −4.891903577 × 10⁻³ |
| A₁₁ | 0.000000000 | 0.000000000 |
| A₁₂ | −9.938967110 × 10⁻⁴ | −7.434724478 × 10⁻³ |
| A₁₃ | 0.000000000 | 0.000000000 |
| A₁₄ | 5.058850919 × 10⁻⁴ | 3.478049180 × 10⁻⁴ |
| A₁₅ | 0.000000000 | 0.000000000 |
| A₁₆ | −1.248499962 × 10⁻⁴ | 8.382608819 × 10⁻⁴ |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 1.7600 |
| Back focal length bf′ (mm) | 0.6895 |
| Lens thickness on optical axis d (mm) | 1.850 |
| Protection layer thickness t (mm) | 0.100 |
| Effective diameter of 1st surface φA (mm) | 2.9920 |
| Effective diameter of 2nd surface φB (mm) | 1.9346 |

Furthermore, FIG. 18 shows a wavefront aberration curve of the objective lens 8 according to Example 11 at the used light having the wavelength λ when the optical recording medium 9 is set.

As shown in FIG. 18, it is clearly observed that the wavefront aberration is good.

As shown in Table 13, the objective lens 8 according to Example 11 satisfies all the conditional expressions (1) to (6) (including the conditional expressions (3′) and (3″)).

### Example 12

The objective lens 8 according to Example 12 consists of a single lens element made of glass. The objective lens 8 according to Example 12 is substantially similar to that according to Example 3, that is, the light source side surface 8a is formed into a convex surface having a large curvature, and the optical recording medium side surface 8b is formed into a convex surface (on the optical axis) having a small curvature.

Furthermore, the both surfaces of the objective lens 8 according to Example 12 are formed into aspheric surfaces.

The objective lens 8 is set to have a numerical aperture NA of 0.85 at the used light having a wavelength λ of 405 nm, and satisfactory converges the light onto the optical recording layer 10 of the optical recording medium (blu-ray disc) 9. Also, the optical recording medium 9 is a double layer disc. When a thickness of the protection layer is considered in view of a design for the double layer disc, 0.0875 mm which is a distance from a surface to a position where aberration is minimized is used in place of the actual thickness of the protection layer.

The upper part of the following Table 12 shows the following items as specific values of lens data of the objective lens 8 according to Example 12: the radius of curvature R (mm); the surface spacing D (mm); and the refractive index N at the light having the wavelength λ.

TABLE 12

| | | |
|---|---|---|
| Wavelength | (nm) | 405 |
| | NA | 0.85 |

| | | Curvature radius | Refractive |
|---|---|---|---|
| Surface | | R (mm) | index N |
| 1 | Aspheric surface | 1.234 | 1.60532 |
| 2 | Aspheric surface | 0.435 | 1.00000 |
| 3 | ∞ | 0.0875 | 1.61900 |
| 4 | ∞ | | |

Coefficients of aspheric surface expression

| | 1st surface | 2nd surface |
|---|---|---|
| C | 1.254840690 | −0.360343050 |
| K | 2.091470453 × 10⁻¹ | 2.100701571 |
| A₃ | 0.000000000 | 0.000000000 |
| A₄ | 8.573709922 × 10⁻² | 1.010322348 |
| A₅ | 0.000000000 | 0.000000000 |
| A₆ | 4.539082073 × 10⁻² | −3.903454125 |
| A₇ | 0.000000000 | 0.000000000 |
| A₈ | 6.361095698 × 10⁻² | 1.182786148 × 10 |
| A₉ | 0.000000000 | 0.000000000 |
| A₁₀ | −1.214879788 × 10⁻¹ | −2.225906681 × 10 |
| A₁₁ | 0.000000000 | 0.000000000 |
| A₁₂ | 2.545589313 × 10⁻¹ | 2.469274350 × 10 |
| A₁₃ | 0.000000000 | 0.000000000 |
| A₁₄ | −2.711337295 × 10⁻¹ | −1.496638681 × 10 |
| A₁₅ | 0.000000000 | 0.000000000 |
| A₁₆ | 1.614060417 × 10⁻¹ | 3.851450783 |
| A₁₇ | 0.000000000 | 0.000000000 |
| A₁₈ | 0.000000000 | 0.000000000 |
| A₁₉ | 0.000000000 | 0.000000000 |
| A₂₀ | 0.000000000 | 0.000000000 |

| | |
|---|---|
| Focal length f′ (mm) | 1.1760 |
| Back focal length bf′ (mm) | 0.4894 |
| Lens thickness on optical axis d (mm) | 1.234 |
| Protection layer thickness t (mm) | 0.0875 |
| Effective diameter of 1st surface φA (mm) | 1.9992 |
| Effective diameter of 2nd surface φB (mm) | 1.5087 |

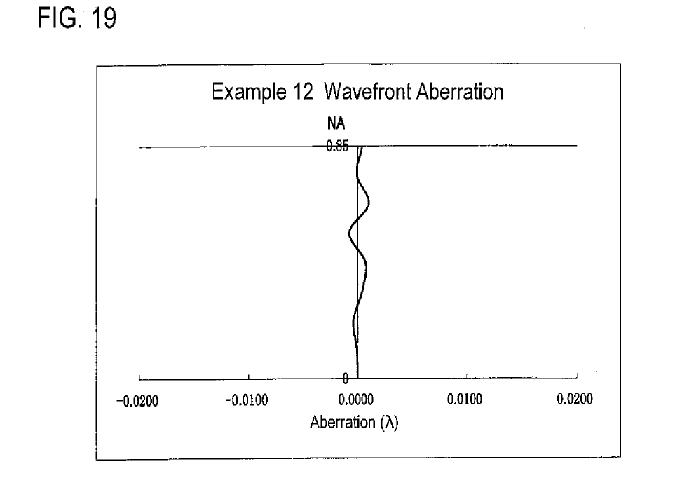

Furthermore, FIG. 19 shows a wavefront aberration curve of the objective lens 8 according to Example 12 at the used light having the wavelength λ when the optical recording medium 9 is set.

As shown in FIG. 19, it is clearly observed that the wavefront aberration is good.

As shown in Table 13, the objective lens 8 according to Example 12 satisfies all the conditional expressions (1) to (6) (including the conditional expressions (3′) and (3″)).

TABLE 13

| | Conditional | Conditional | Conditional | Conditional | Conditional | |
|---|---|---|---|---|---|---|
| | Expressions | Expression | Expression | Expression | Expression | |
| | (1), (3), (3′), (3″) | (2) | (4) | (5) | (6) | |
| | φA/φB | φA/φB + 19.33 × bf′/f′ | φA (mm) | NA | t1 (mm) | λ (nm) |
| Example 1 | 1.7398 | 8.20 | 3.8862 | 0.85 | 0.100 | 404.7 |
| Example 2 | 1.9150 | 7.81 | 2.9920 | 0.85 | 0.100 | 404.7 |
| Example 3 | 1.5287 | 7.70 | 3.0011 | 0.85 | 0.100 | 408.0 |
| Example 4 | 1.8344 | 7.95 | 1.9992 | 0.85 | 0.0875 | 405.0 |
| Example 5 | 1.5052 | 8.31 | 3.7400 | 0.85 | 0.0875 | 405.0 |
| Example 6 | 4.7078 | 7.71 | 2.9924 | 0.85 | 0.100 | 405.0 |
| Example 7 | 4.4901 | 8.87 | 2.9920 | 0.85 | 0.100 | 405.0 |
| Example 8 | 3.2836 | 8.41 | 2.9920 | 0.85 | 0.100 | 405.0 |
| Example 9 | 2.5792 | 8.90 | 2.9920 | 0.85 | 0.100 | 405.0 |
| Example 10 | 1.6933 | 7.91 | 1.9992 | 0.85 | 0.0875 | 405.0 |
| Example 11 | 1.5466 | 9.12 | 2.9920 | 0.85 | 0.100 | 405.0 |
| Example 12 | 1.3251 | 9.37 | 1.9992 | 0.85 | 0.0875 | 405.0 |

Furthermore, the objective lens according to the invention is not limited to ones described above, and may be modified in various ways. Also, the optical pickup device and the recording and/or reproducing apparatus for an optical recording medium according to the invention also may be modified in various ways.

For example, the objective lens according to the invention is not limited to the configuration in which all of the light source side surface and the optical recording medium side surface are formed into rotationally symmetric aspheric surfaces as in Examples. If at least one surface (in the case of one surface, it is preferable to select the light source side surface) is formed into an aspheric surface, the other surface may be formed into a flat surface or a spherical surface.

Furthermore, in future, an optical recording medium conforming to a standard in which a wavelength of the used light is further shortened toward ultraviolet region may be developed. Even in that case, the invention can be applied. In this case, as a lens material, it is preferable to use a material having excellent transmittance at a wavelength of the used light. For example, it is possible to use fluorite or quartz as a lens material of the objective lens according to the invention.

What is claimed is:

1. An objective lens for converging used light on a desired position of an optical recording medium which information is recorded in and reproduced from, the objective lens consisting of:
a single lens element having at least one aspheric surface, wherein the following conditional expressions (1) and (2) are satisfied
ΦA/ΦB≦5.0 (1)
7.69≦ΦA/ΦB+19.33×bf′/f′≦9.45 (2),
where ΦA denotes an effective diameter, in mm, of a light source side surface of the objective lens,
ΦB denotes an effective diameter, in mm, of an optical recording medium side surface of the objective lens,
bf′ denotes a back focal length of the objective lens in mm, and
f′ denotes a focal length of the objective lens in mm.

2. The objective lens according to claim 1, wherein the following conditional expression (3) is further satisfied.
1.0≦ΦA/ΦB≦5.0 (3)

3. The objective lens according to claim 1, wherein the following conditional expression (3′) is further satisfied.
1.0≦ΦA/ΦB≦3.0 (3′)

4. The objective lens according to claim 1, wherein the following conditional expression (3−) is further satisfied.
1.0≦ΦA/ΦB≦2.0 (3″)

5. The objective lens according to claim 1, wherein the following conditional expression (4) is further satisfied.
1.0 mm≦ΦA≦5.0 mm (4)

6. The objective lens according to claim 1, wherein the following conditional expression (5) is further satisfied.
0.70<NA<0.98 (5)

7. The objective lens according to claim 1, wherein a wavelength of the used light is 405.0±5.0 m.

8. The objective lens according to claim 1, wherein
a wavelength of the light is 405.0±5.0 nm,
the numerical aperture NA is 0.85, and
a thickness t of a protective layer of the optical recording medium is 0.1 mm.

9. The objective lens according to claim 1, wherein
a wavelength of the light is 405.0±5.0 nm,
the numerical aperture NA is 0.85,
aberration is minimized at a position being distant t1 mm from a surface of the optical recording medium to an inside of the optical recording medium, and
the following conditional expression (6) is satisfied.
0.075≦t1≦0.1 (6)

10. The objective lens according to claim 1, wherein a mass of the objective lens is 0.5 grams or less.

11. An optical pickup device comprising:
the objective lens according to claim 1; and
an actuator that performs a focusing operation of the objective lens and a tracking operation of the objective lens.

12. A recording and/or reproducing apparatus for an optical recording medium, the apparatus comprising
the optical pickup device according to claim 11.
